(19) United States
(12) Patent Application Publication
(10) Pub. No.: US 2006/0039020 A1
(43) Pub. Date: Feb. 23, 2006

(54) Image supply device, control method thereof and printing system

(75) Inventor: Futoshi Sasaki, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/206,066

(22) Filed: Aug. 18, 2005

(30) Foreign Application Priority Data
Aug. 20, 2004 (JP) 2004-241201
Aug. 20, 2004 (JP) 2004-241202

(51) Int. Cl. G06F 3/12

(52) U.S. Cl. 358/1.13

(57) ABSTRACT

A printing system having a DSC and a printer that prints an image based on image data supplied from the DSC, in which the DSC acquires print function information-of the printer in accordance with a communication with the printer, configures and displays a UI based on the print function information, makes the resizing and/or rotation of the image data to be printed in accordance with a print size and a print direction set based on the UI and the print function information, and transmits the converted image data to the printer in response to a data request from the printer and the printer prints an image based on the image data.

### FIELD OF THE INVENTION

The present invention relates to a printing system having an image supply device and a printer that prints an image based on image data supplied by the image supply device, the image supply device and a control method of the image supply device.

### BACKGROUND OF THE INVENTION

A so-called digital camera direct print system (direct printing system using digital camera) has been generally employed in which a printer and a digital still camera (hereinafter a DSC) are directly connected through an interface such as USB, and image data stored in a storage medium (memory card) of the DSC is sent to the printer and printed.

In such printing system, it is common to send a JPEG file of the image to be printed from the DSC to the printer, and convert the JPEG file into a printable data format by making decoding, color conversion and resizing of the JPEG file to print the converted image data by the printer.

In Japanese Patent Application Laid-Open No. 8-32911, a camera system that can output proper image data from a DSC according to the specifications of a printer was proposed. However, the object of the invention of the above patent solves the trouble in which a part of an image is not printed or an image is not printed in the worst case. Further, according to the prior art (8-32911), print is performed using a less universal print protocol being different for every camera.

In the print protocol that deals with the image file of general file format such as the JPEG between a camera and a printer, the image data can be printed by making the decoding, resize and rotation processing for the image data on the printer, if there is information of image width, image height, image direction and file size. Therefore, the trouble in which a part of an image is not printed does not occur.

In the conventional printing process via a PC, image data to be printed is converted into a color space supported by a printer on the PC, sent to the printer by a printer driver and printed. However, in the direct print system using a digital camera, there is no printer driver or equivalent, and the image data to be printed is sent from the camera to the printer and printed. Therefore, there is a problem that the colors of the image photographed by the camera can not be faithfully reproduced by the printer because the colors are not supported by the printer, even if the colors of the image are treated as a general color space.

On the other hand, the image processing executed in the printer may be performed by the camera, and the print data created by making the image processing on the camera may be transferred to the printer. However, in such a case, an amount of the print data becomes large in accordance with the resolution of the printer. Therefore, in the current printer of high resolution, the volume of print data becomes enormous, resulting in the problem in which the transfer time of the print data becomes long and the memory capacity of storing the data in the printer becomes large.

Moreover, in the case where a printer reads image data compressed in the JPEG format stored in a camera and makes image processing on the image data to print, the printer reads the image data stored in the camera directly through the interface such as USB. However, along with the higher resolution of the camera in recent years, an amount of image data increases, so that it takes a long time to read the image data through the interface. If the image data of such high resolution is printed in a comparatively small size, all pixel data of the image data are not used for printing but printed after the image data has been thinned out. In other words, even if the image data is transferred from the camera to the printer at a lot of time, whole the image data is not used for print, and the remaining data is discarded without contributing to the printing, resulting in the worse processing efficiency as a whole.

In addition, the processing time for converting the image data of the JPEG stored in the camera into the CMYK image data suitable for printing on the printer becomes longer, but it also takes a lot of time to convert into the oblong, rectangular image photographed by the camera into the longitudinal rectangular image according to the direction where a sheet is conveyed for printing in the printer. In this case, the printer must rotate the received image data by 90 degrees, 180 degrees or 270 degrees. Such rotation processing, as well as the color conversion processing from RGB to CMYK, becomes a heavy load on a CPU of the printer.

In Japanese Patent Application Laid-open No. 10-290470, in order to decrease the processing load of the printer, it is proposed that a camera converts image data into the printable data by making the decoding, color conversion and resizing of the JPEG file and sends the printable data to the printer. Also, in Japanese Patent Application Laid-open No. 2003-134457, it is pointed out that the variation of the color reproduction characteristic for each printer is corrected by a DSC, and the DSC sends the general image file such as JPEG to the printer. As a result, it is possible to obtain the steady image that does not depend on the print characteristics of each printer.

Moreover, it is well known to select “borderless” or “bordering” upon printing the image photographed by the DSC. It is fundamental that an image is printed over a whole printing paper with the image data of the size smaller than that of the original image data in “borderless” printing, while 100% of the photographed image is printed on a printing paper in “bordering” printing.

However, when a large amount of image data is reduced in accordance with the printing size, and the reduced image data is printed with “bordering”, the image is converted into somewhat smaller size of image by truncating a fraction part of the image, and printed with “bordering”. Therefore, it is not assured that 100% of the photographed image can be printed in the “bordering” printing, as described above.

### SUMMARY OF THE INVENTION

An object of the invention is to solve the above-mentioned problems associated with the prior art.

The feature of the present invention is to provide an image supply device, a device control method and a printing system in which an image is printed by decreasing an amount of image data transferred to a printer and relieving the processing load of the printer.

Also, another feature of the invention is to provide an image supply device, a device control method and a printing system in which even when an image is resized in borderless printing, it is possible to prevent a part of the image from being truncated.

According to an aspect of the present invention, there is provided with a printing system having an image supply device and a printer, for printing an image based on image data supplied from the image supply device, wherein the image supply device comprising:

storage means for storing coded image data;

means for acquiring print function information of the printer in accordance with a communication between the image supply device and the printer;

means for configuring and displaying a UI based on the print function information;

conversion means for making resizing and/or rotation of the image data to be printed that is stored in the storage means, in accordance with a print size and a print direction set based on the UI and the print function information; and

transmission means for transmitting the image data converted by the conversion means to the printer in response to a data request the the printer;

wherein the printer prints an image based on the image data transmitted by the transmission means in response to the data request.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 depicts a schematic perspective view of a photo-direct printer according to an embodiment of the present invention;

FIG. 2 depicts a schematic view showing an operation panel of the PD printer according to the embodiment;

FIG. 3 is a block diagram showing the arrangement of principal elements concerning control of the PD printer according to the embodiment;

FIG. 4 is a block diagram showing the construction of a DSC according to the embodiment;

FIG. 5 depicts a diagram for explaining the signal flow of printing by issuing a print request from the DSC to the PD printer in a print system;

FIG. 6 is a functional block diagram showing the functional configuration of the print system according to the embodiment;

FIG. 7 is a diagram for explaining a printing process of supplying the image data from the DSC to the PD printer by making the communication between the digital camera and the PD printer according to a first embodiment of the invention;

FIGS. 8A to 8C depict views for explaining the examples of image data printed in the print system according to the embodiment;

FIG. 9 is a flowchart for explaining a process up to creating a print job file that is performed by the DSC of the print system according to the embodiment;

FIG. 10 is a flowchart for explaining a process of creating a print image file in the DSC corresponding to the processing of steps S7 to S9 of FIG. 7;

FIG. 11 is a flowchart for explaining a process of the DSC for a “request for image file” from the PD printer;

FIGS. 12A and 12B depict views for explaining a modified embodiment of the first embodiment;

FIG. 13 depicts a view showing an example of a UI screen according to a second embodiment of the invention;

FIG. 14 is a flowchart for explaining a process in the DSC for setting up the priority level of color conversion according to the second embodiment of the invention;

FIG. 15 depicts a view showing a screen for designating a print position of the date according to a third embodiment of the invention;

FIG. 16 is a flowchart for explaining a process for designating the date print position in the DSC according to the third embodiment of the invention;

FIG. 17 is a flowchart for explaining a process in the DSC according to a fourth embodiment of the invention;

FIG. 18A depicts a view showing an image photographed by the DSC according to a fifth embodiment of the invention, and FIG. 18B depicts a view showing a resized image in which the image is resized based on the longitudinal and transverse numbers of pixels in the image to be printed by the PD printer;

FIGS. 19A and 19B depict views showing the examples where the image data after resizing (3066 pixels in width×2044 pixels in height) as shown in FIG. 18B is printed with “bordering”;

FIGS. 20A and 20B depict views showing the examples where the image data after resizing (3066 pixels in width×2044 pixels in height) as shown in FIG. 18B is printed with “borderless”;

FIG. 21 is a flowchart for explaining a process of creating a print image file in the DSC 3012 corresponding to the processing of steps S7 to S9 in FIG. 7;

FIG. 22 is a flowchart for explaining a “bordering”/“borderless” process at step S216 in FIG. 21; and

FIG. 23 is a flowchart for explaining a process according to a sixth embodiment of the invention.

### DETAILED DESCRIPTION OF THE PREFERRED EMBODIMENTS

Preferred embodiments of the present invention will now be described in detail with reference to the accompanying drawings. It should be noted that the embodiments that follow do not limit the invention set forth in the claims and that all combinations of features described in the embodiments are not necessarily essential as means for attaining the invention. This embodiment will be described as to the case of implementing direct print between a digital camera (DSC) and a printer. However, the present invention is not limited thereto.

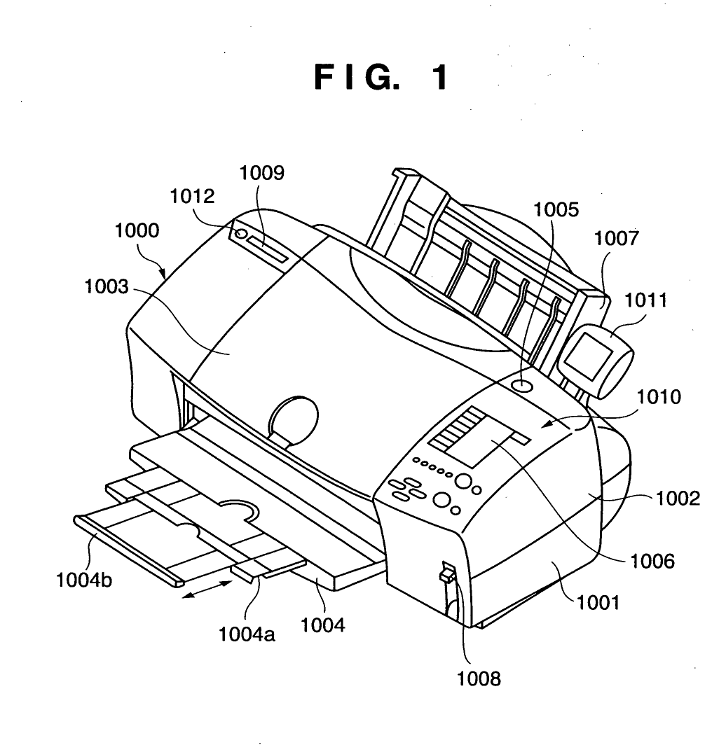

FIG. 1 depicts a perspective view of a photo-direct printer (hereinbelow, PD printer) 1000 according to an embodiment of the present invention. The PD printer 1000 has a general PC printer function of receiving data from a host computer (PC) and print-outputting the data, and a function of directly reading image data stored in a storage medium such as a memory card or receiving image data from a digital camera and performing printing.

In FIG. 1, the main body as an outer shell of the PD printer 1000 has a lower case 1001, an upper case 1002, an access cover 1003 and a discharge tray 1004. The lower case 1001 forms an approximate lower half part of the PD printer 1000, and the upper case 1002 forms an approximate upper half part of the main body. The combination of both cases produces a hollow structure having accommodation space for respective mechanisms to be described later. The structure has openings in its upper surface and front surface. Further, the discharge tray 1004 is rotatably held at its one end in the lower case 1001. The rotation of the discharge tray 1004 opens/closes the opening in the front surface of the lower case 1001. In this arrangement, upon execution of print operation, the discharge tray 1004 is rotated to the front surface side to open the opening, thereby print sheets can be discharged from the opening and the discharge print sheets can be sequentially stacked. The discharge tray 1004 includes two auxiliary trays 1004a and 1004b. The sheet support area of the discharge tray 1004 can be expanded or reduced in three steps by pulling out the respective trays in accordance with necessity.

The access cover 1003, rotatably held at its one end in the upper case 1002, opens/closes the opening formed in the upper surface. When a printhead cartridge (not shown), an ink tank (not shown) or the like accommodated in the main body is exchanged, the access cover 1003 is opened. Note that although not particularly shown, when the access cover 1003 is opened/closed, a projection formed on the rear surface of the access cover 1003 rotates a cover opening/closing lever with a micro switch or the like. The open/close status of the access cover 1003 can be detected by detecting the rotated position of the lever.

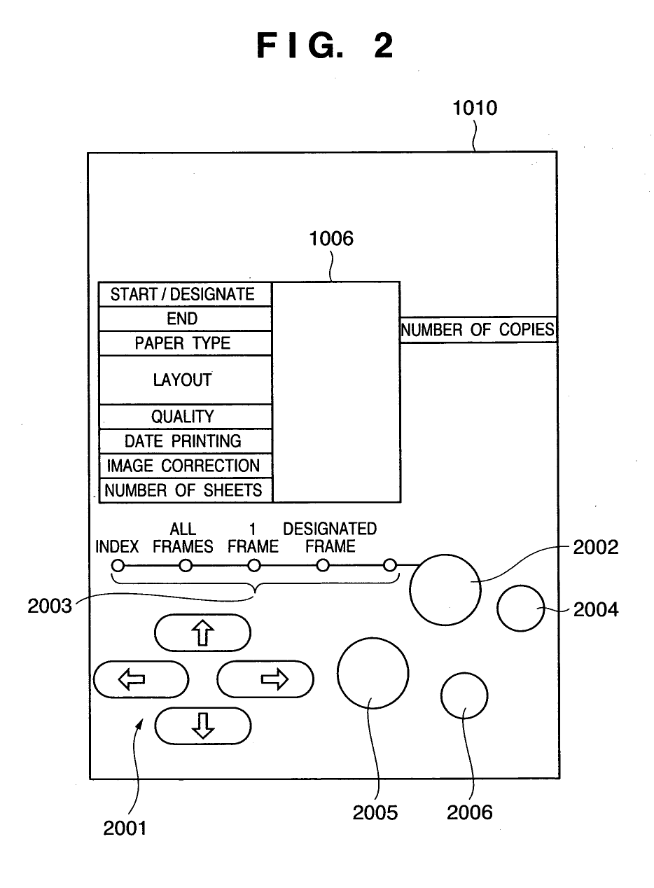

A power key 1005 is provided on the upper surface of the upper case 1002. Further, an operation panel 1010 having a liquid crystal display 1006, various key switches and the like, is provided on the right side of the upper case 1002. The structure of the operation panel 1010 will be described in detail with reference to FIG. 2. Reference numeral 1007 denotes an automatic feeder which automatically feeds print sheets into the apparatus main body. Numeral 1008 denotes a sheet interval selection lever to control the interval between a printhead and a print sheet. Numeral 1009 denotes a card slot into which an adapter, to which a memory card is attachable, is inserted. Image data stored in the memory card is directly read via the adapter and print-outputted. As the memory card (PC), compact flash (registered trademark) memory, smart media, memory stick and the like may be used. Numeral 1011 denotes a viewer (liquid crystal display) attachable/removable to/from the PD printer 1000 main body. In a case where the PC card is searched for an image to be printed, images are displayed by 1 frame or index images are displayed on the viewer. Numeral 1012 denotes a USB terminal for connection with a digital camera to be described later. Further, a USB connector for connection with a personal computer (PC) is provided on a rear surface of the PD Printer 1000.

FIG. 2 depicts a schematic view showing the operation panel 1010 of the PD printer 1000 according to the present embodiment.

In FIG. 2, the liquid crystal display 1006 displays a menu items for various settings of data regarding items printed on left and right sides. The displayed items include, e.g., a head picture number of plural image files to be printed, a designated frame number (start frame designation/print frame designation), a last picture number to be printed (end), the number of printouts (copies), the type of paper (print sheet) used in printing (paper type), the number of pictures printed on one sheet (layout), designation of printing quality (quality), designation as to whether or not date of photographing is to be printed (date printing), designation as to whether or not picture correction is made before printing (image correction), the number of necessary print sheets (number of sheets) and the like. The respective items are selected or designated with a cursor key 2001. Numeral 2002 denotes a mode key. The type of printing (index printing, all frame printing, one frame printing and the like) is changed by each depression of the mode key 2002, and a corresponding LED of the LED 2003 is turned on. Numeral 2004 denotes a maintenance key for performing printer maintenance such as cleaning of the print head; numeral 2005 denotes a print start key which is depressed to designate the start of printing or establish maintenance setting; and numeral 2006 denotes a print stop key which is depressed to stop printing or designate to stop a maintenance processing.

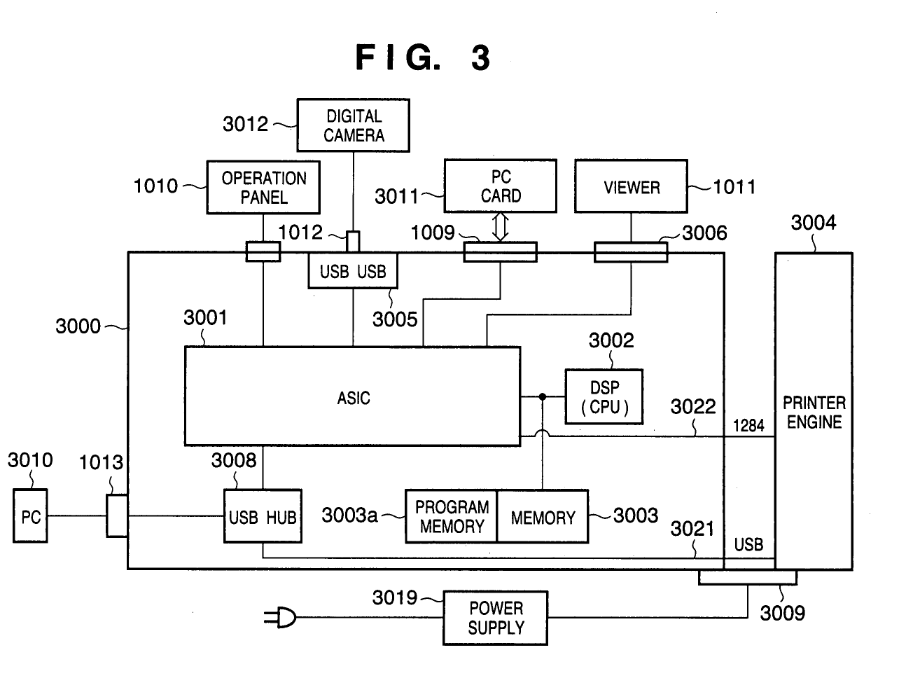

Next, the arrangement of the principal elements concerning control of the PD printer 1000 according to the present embodiment will be explained with reference to FIG. 3. In FIG. 3, elements corresponding to those in the above-described figures have the same reference numerals, and explanations thereof will be omitted.

FIG. 3 is a block diagram showing an arrangement of principal elements concerning control of the PD printer according to the embodiment.

In FIG. 3, numeral 3000 denotes a controller (control board); numeral 3001 denotes an ASIC (application specific LSI); numeral 3002 denotes a DSP (Digital Signal Processor) which incorporates a CPU and performs various control processings to be described later and image processings such as conversion from luminance (RGB) signals to density (CMYK) signals, scaling, gamma conversion, and error diffusion; numeral 3003 denotes a memory having a program memory 3003a for storing the control program for the CPU of the DSP 3002, a RAM area for storing variables and the like upon execution of program, and a memory area functioning as a work memory for storing image data and the like; numeral 3004 denotes a printer engine which is an ink-jet print type printer engine for printing a color image by using a plurality of color inks; numeral 3005 denotes a USB connector serving as a port for connection with a digital camera (DSC) 3012; numeral 3006 denotes a connector for connection with the viewer 1011; and numeral 3008 denotes a USB hub which transmits data from a PC 3010 to the printer engine 3004 via a USB 3021 when the PD printer 1000 performs printing based on image data from the PC 3010. Thus, the connected PC 3010 can directly exchange data and signals with the printer engine 3004 and execute printing (functions as a general PC printer). Numeral 3009 denotes a power connector which receives a DC voltage converted from a commercial AC voltage from a power supply 3019. The PC 3010 is a general personal computer; numeral 3011 denotes the above-described memory card (PC card); and numeral 3012 denotes the digital camera (DSC: Digital Still Camera).

Note that signal exchange between the controller 3000 and the printer engine 3004 is performed via the above-described USB 3021 or an IEEE 1284 bus 3022.

<Overview Description of Digital Camera>

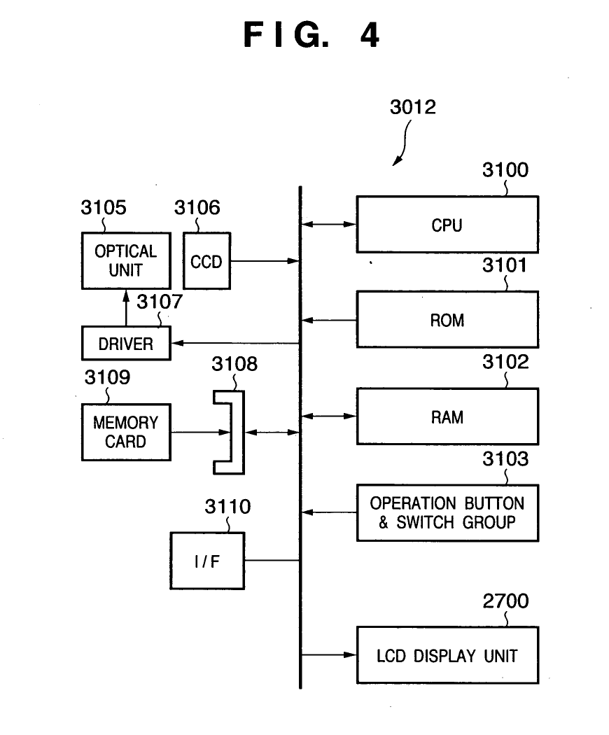

FIG. 4 is a block diagram showing the construction of a DSC (digital camera) 3012 according to the present embodiment.

In FIG. 4, numeral 3100 denotes a CPU which controls the overall DSC 3012; numeral 3101 denotes a ROM holding a processing procedure by the CPU 3100; numeral 3102 denotes a RAM used as a work area for the CPU 3100; numeral 3103 denotes a switch group for various operations including various switches and cursor keys; numeral 2700 denotes a liquid crystal display to display a currently-sensed video image, images already obtained by image sensing and stored, or to made various settings (UI image); numeral 3105 denotes an optical unit mainly comprising a lens and its drive system; numeral 3106 denotes a CCD device; numeral 3107 denotes a driver to drive-control the optical unit 3105 under the control of the CPU 3100; numeral 3108 denotes a connector for connection with the storage medium 3109 (compact flash (registered trademark) memory card, smart media and the like); and numeral 3110 denotes a USB interface (on the USB slave side) for connection with the PC or the PD printer 1000 in the present embodiment.

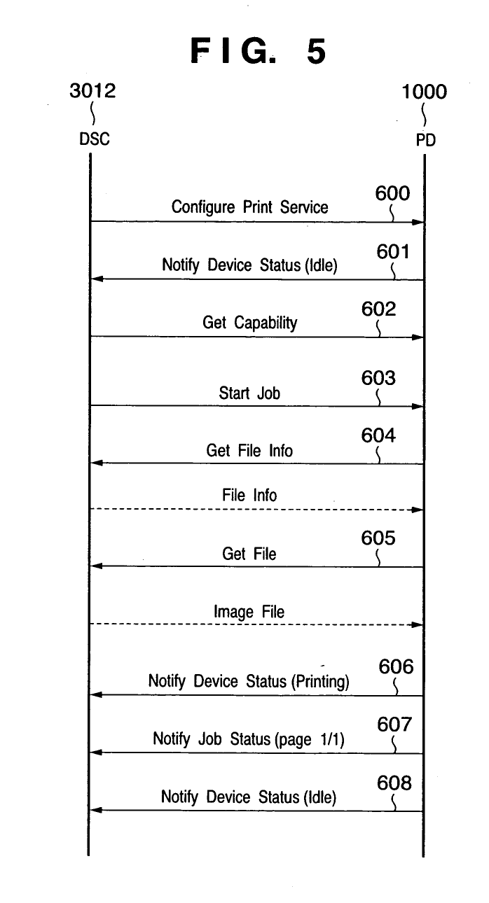

FIG. 5 is a diagram for describing a rough signal flow in the case of issuing a print request from the DSC 3012 to the PD printer 1000 and performing printing in a printing system.

This procedure is implemented after connecting the PD printer 1000 to the DSC 3012 via a USB cable or after mutually confirming compliance with DPS specifications by performing radio communication. First, the DSC 3012 transmits “ConfigurePrintService” to the PD printer 1000 so as to check a status of the PD printer 1000 (600). In response, the PD printer 1000 notifies the DSC 3012 of the status of the PD printer 1000 at the time (an “Idle” status in this case) (601). As it is the “Idle” status in this case, the DSC 3012 inquires about Capability (printing functions) of the PD printer 1000 (602) and issues a print start request (StartJob) according to the Capability (603). This print start request is issued from the DSC 3012 to the PD printer 1000 on condition that “newJobOK” in status information from the PD printer 1000 described later is “True” in 601.

In response to this print start request, the PD printer 1000 requests file information (information of file: information of size and color space of image and the like) from the DSC 3012 based on a file ID of the image data instructed to print (GetFileInfo) (604). The file information is transmitted from the DSC 3012 in reply. This file information includes the information such as a file capacity. The PD printer 1000 receives the file information and if the printer determines it to be able to process, the printer requests the file to the DSC 3012 (GetFile) (605). Thus, the image data of the requested file (ImageFile) is transmitted from the DSC 3012 to the PD printer 1000. If the PD printer 1000 thereby starts a print process, the status information indicating “Printing” is transmitted by a “NotifyDeviceStatus” from the PD printer 1000 to the DSC 3012 in 606. If the print process of one page is finished, it is notified by a “NotifyJobStatus” 607 from the PD printer 1000 when starting the process of the next page. In the case of printing only one page, on finishing printing the one page requested to print, it is notified next by a “NotifyDeviceStatus” 608 that the PD printer 1000 is now in the “Idle” status (NotifyDeviceStatus(Idle)).

In the case of N-up printing for laying out and printing multiple (N) images on one page for instance, the “NotifyJobStatus” 607 is transmitted from the PD printer 1000 to the DSC 3012 each time in which N images have been printed. Order of timing for issuing the “NotifyJobStatus” and “NotifyDeviceStatus” and acquisition of the image data in this embodiment is just an example, and there are various possible cases depending on implementation of the product.

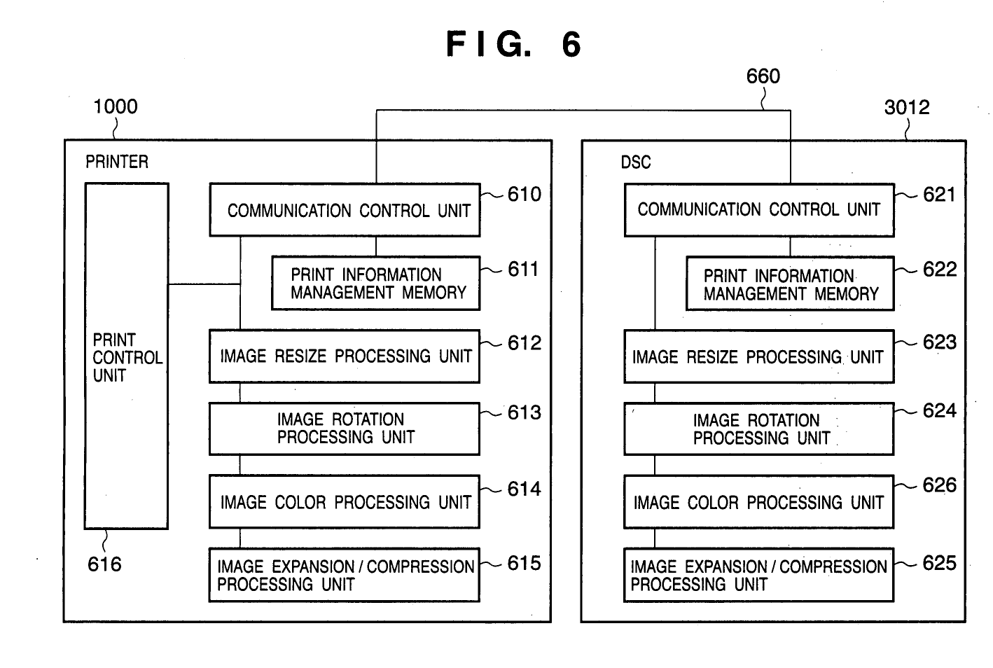

FIG. 6 is a functional block diagram showing the functional configuration of the print system according to the embodiment of the invention. This print system has the PD printer 1000 and the DSC 3012, which are interconnected via an interface 660 such as USB. This interface 660 is wired, but may be a wireless interface such as Bluetooth.

As the functions of the PD printer, the PD printer 1000 comprises a communication control part 610 for controlling the communication via the interface 660, a print information management memory 611 including a print buffer and a receiving buffer, an image resizing processing unit 612 for resizing an image, an image rotation processing unit 613 for rotating an image, an image color processing unit 614 for making the color conversion of an image, an image expansion/compression processing unit 615 for expanding and compressing image data, and a print control unit 616 having a printer engine 3004. The image resize processing unit 612, the image rotation processing unit 613, the image color processing unit 614 and the image expansion/compression processing unit 615 are implemented by the DSP 3002 and a program stored in the program memory 3003a in this embodiment.

Also, as the functions of the DSC, the DSC 3012 comprises a communication control unit 621 for controlling the communication via the interface 660, a print information management memory 622 including a RAM 3102 storing the processed image data, an image resize processing unit 623 for resizing an image, an image rotation processing unit 624 for rotating an image, an image expansion/compression processing unit 625 for expanding and compressing image data, and an image color processing unit 626 for making the color conversion. The image resize processing unit 623, the image rotation processing unit 624, the image expansion/compression processing unit 625 and the image color processing unit 626 are implemented by the CPU 3100 and a program stored in the ROM 3103 in this embodiment.

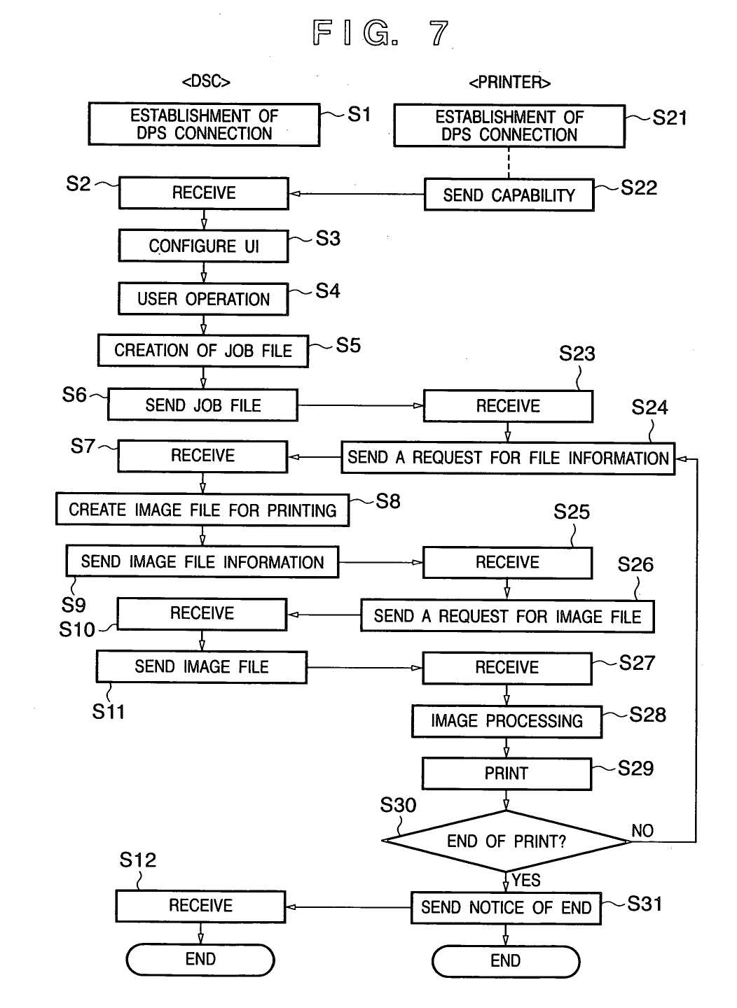

FIG. 7 is a diagram for describing the process in the case of performing communication between the digital camera (DSC) 3012 and the PD printer 1000 and supplying the image data from the DSC 3012 to the PD printer 1000 to perform the printing according to the first embodiment of the present invention. In FIG. 7, steps S1 to S12 indicate the processes of the DSC 3012 and steps S21 to S31 indicate the processes of the PD printer 1000.

In the steps S1 and S21, the DSC 3012 and the PD printer 1000 mutually confirm the compliance with the DPS specifications. In this state, the DSC 3012 inquires the PD printer 1000 about the status of the printer and device information. In response, the PD printer 1000 notifies it of the status of the PD printer 1000 and the device information at the time. The device information includes notification of a version of a connection protocol and a vendor name and a type of the printer. The DSC 3012 stores in an RAM 3102 as necessary information out of the printer status and device information. Next, the DSC 3012 requests the Capability of the PD printer 1000 as indicated by reference numeral 602 in FIG. 5.

The PD printer 1000 thereby creates capability information (Capability) on printing functions of the PD printer 1000 and transmits it to the DSC 3012 in the step S22. The DSC 3012 receives this Capability (step S3). And the DSC establishes a UI based on the Capability and displays it on a display 2700 in the step S3. Here, for instance, in the case where paper sizes are A4 and B5, the PD printer 1000 has plain paper and photo paper mounted thereon, and layout printing of 1-up, 2-up and 4-up is possible “borderless” or “bordering” and date printing is further possible, a UI screen capable of arbitrarily selecting any of the above described items while incapable of selecting any other item is displayed on the display 2700.

Next, in the step S4, the user of the DSC 3012 refers to the established UI screen, selects the images to be printed and sets up a print form and printing conditions of the image. The setup of the print form and printing conditions of the images are based on the Capability of the PD printer 1000 received in the step S2, such as the number of print sheets, paper size, layout and whether or not there is date printing, and the print form and printing conditions are stored in the RAM 3102. If instructed to start printing by the user by using the UI, it advances to the step S5 to create a print job file to give instructions of the printing, and transmits the created print job file to the PD printer 1000 in the step S6.

The print job file is received by the PD printer 1000 in the step S23. Next, in the step S24, the PD printer 1000 analyzes the received print job file to prepare for the print. And the printer issues a “request for image file information” (image file name) of a printing subject listed in the print job file to the DSC 3012.

In the case of a service operating on a PTP (Picture Transfer Protocol) on a USB, the “request for image file information” is equivalent to “GetobJectInfo” provided by the PTP. However, the “request for image file information” in this embodiment plays a role of transmitting the timing for creating the image file from the PD printer 1000 to the DSC 3012.

And when the “request for image file information” is received by the DSC 3012 in the step S7, it advances to the step S8 and performs the process of creating the image file to be printed which is to be transmitted to the PD printer 1000, which characterizes this embodiment. The process of the step S8 will be described in detail later. Next, in the step S9, the information of the created image file to be printed (including ObjectInfoDataset: image file name, data size, directory, date and so on) is transmitted to the PD printer 1000.

Next, on receiving the image file information in the step S25, the PD printer 1000 transmits the request for the specified image file to be printed to the DSC 3012 (step S26). On receiving the request for image file (step S10), the DSC 3012 transmits the requested image file to be printed to the PD printer 1000 in the step S11.

On receiving the image file in the step S27, the PD printer 1000 performs image processing by decoding the image data of the image file so as to convert it into image data in the format to be printed by the PD printer 1000 (step S28). And the printer performs printing based on the converted image data in the step S29. In the step S30, it determines whether or not the printing has been completed to the end of the image data. In the case where the printing has not been completed here, because of, for example, that a buffer area for storing the received image data cannot be sufficiently secured on the PD printer 1000, and the image data of the image file is dividedly received and processed in the step S27. In such case, the process returns to the step S24 and transmits the “request for image file information” to the DSC 3012 again so as to receive and print partial data of the image data of the image file by using the same procedure as previously described in the step S27.

Thus, on completing the printing of the image data of the image file in the step S30, the process advanced to the step S31 to notify the DSC 3012 of completion of the printing of the image file. On receiving this printing completion notice, the DSC 3012 terminates the process.

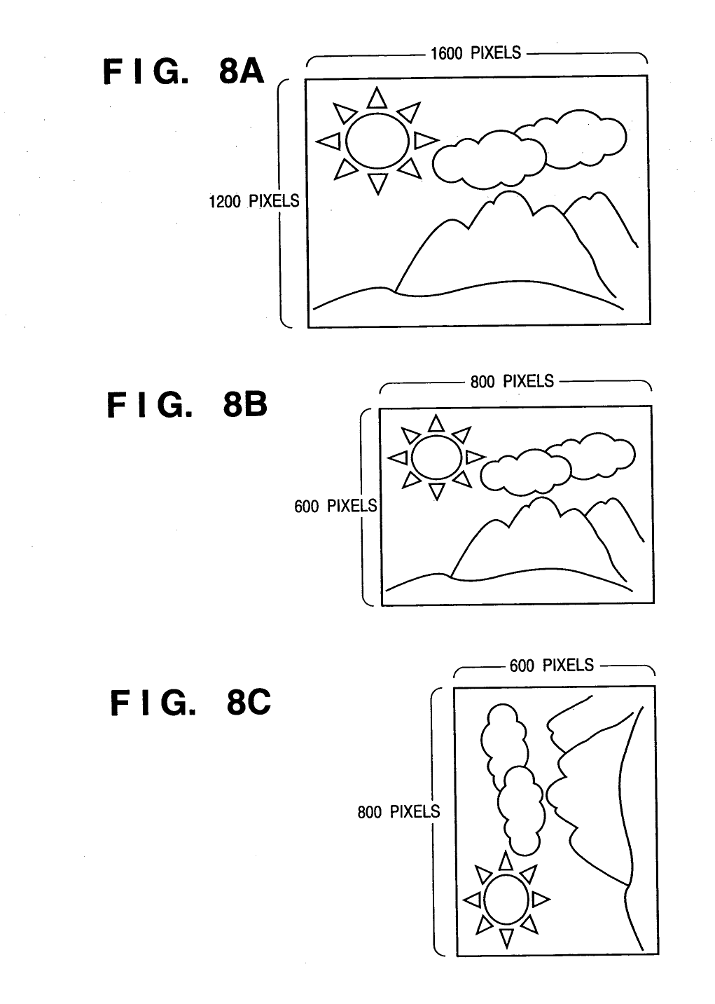

FIGS. 8A to 8C depict views for explaining the examples of image data printed by the print system according to the embodiment.

FIG. 8A shows an example of an image taken by the DSC 3012, its size being 1200 pixels longitudinally and 1600 pixels transversely. FIG. 8B shows the resized image (600 pixels longitudinally and 800 pixels transversely) based on the longitudinal and transverse numbers of pixels that can be printed by the PD printer 1000 under the printing conditions of the PD printer 1000. Moreover, FIG. 8C shows an example in which the image of FIG. 8B is rotated by 90 degrees in correspondence with a direction of sheet on the PD printer 1000.

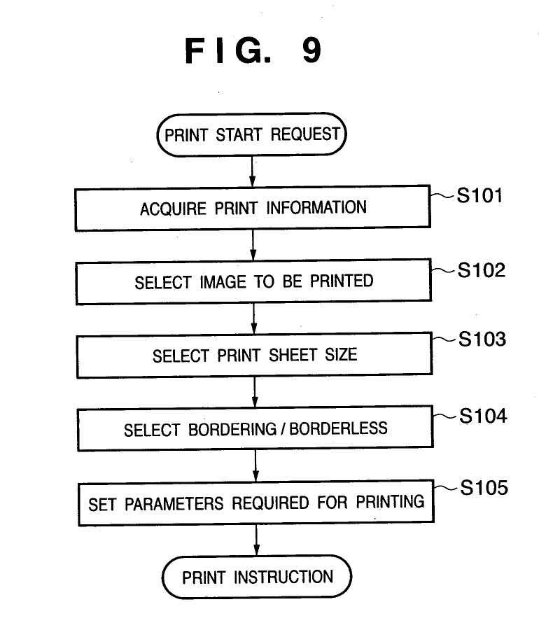

FIG. 9 is a flowchart for explaining a process up to creating a print job file that is performed by the DSC 3012 of the print system according to the embodiment, in which this process corresponds to the steps S2 to S4 of FIG. 7.

At step S101, the Capability is received from the PD printer 1000 to acquire the paper size and the print resolution of the PD printer 1000. At this time, the PD printer 1000 calculates the longitudinal and transverse numbers of pixels of an image to be printed. The calculated longitudinal and transverse numbers of pixels of a printable image are transmitted from the communication control unit 610 of the PD printer 1000 to the communication control unit 621 of the DSC 3012 in accordance with a communication protocol as defined between the PD printer 1000 and the DSC 3012. The transmitted numbers of pixels are stored in the RAM 3102 of the DSC 3012. Herein, in the case where the printer 1000 is a type of being incapable of transmitting the numbers of pixels of the printable image by the printer to the DSC 3012, the longitudinal and transverse numbers of pixels for each print sheet and the print direction may be obtained by referring to a table (not shown) in the DSC 3012 based on the device type information obtained from the printer, including the bender name, device type name and version number of the printer, and the number of pixels of the printable image by the printer can be calculated.

In this way, in the case where the PD printer 1000 can not transmit the longitudinal and transverse numbers of pixels of the printable image, it is possible for the printer to print an image at higher quality by converting the image data sent to the printer based on the information prestored in the DSC 3012, even if the functions of the printer are inferior in the communication ability or image processing ability. Moreover, even with its inferior functions of the printer, the printed image having the required minimum image quality is secured. Of course, in this case, though the number of pixels may not be optimal for the printer, there is the great effect to suppress the communication error or increased communication time only by preventing too excessively large image data from being sent to the printer.

Upon determining whether or not the longitudinal and transverse numbers of pixels can be transmitted from the PD printer 1000 to the DSC 3012, it is preferable to check the version of the communication protocol at the time of connection between the printer and the DSC. This is because whether or not the information as to the number of pixels is transmitted may often depend on the communication protocol itself. And if the version of the communication protocol is the version where it is not possible to exchange the information as to the number of pixels between the printer and the DSC, it is preferable to decide the longitudinal and transverse numbers of pixels of the printable image by referring to the table (not shown) stored in the DSC 3012.

Similarly, for the rotation processing, it is possible for the DSC 3012 to determine whether or not the printer is the type capable of rotating image data based on the version of the communication protocol. If the version of the communication protocol indicates that the printer is incapable of the rotation processing, it may be possible to determine whether or not the image data to be outputted to the printer is rotated by referring to the table stored in the DSC 3012 and in view of the layout of the image.

In this way, the DSC 3012 determines whether or not to make the resizing or rotation of image data to be sent to the printer, based on the version information of the communication protocol. Thereby, since the processing for the image data can be decided based on the result of negotiation of the communication protocol that is performed at the initial stage of communication, the subsequent image processing or print processing is smoothly performed in user-friendly manner.

At step S102, the user selects the image to be printed, based on the UI displayed on the display 2700. Further, the user selects the paper size for printing the selected image at step S103 and selects the print layout of “bordering/borderless” at step S104. Thus, at step S105, the parameters required for printing are selected and set up. If the print start is instructed on the UI screen, creation (S5) of a print job file is started in the DSC 3012. The processing of steps S102 to S105 corresponds to the processing of step S4 of FIG. 7. The created print job file is sent to the PD printer 1000 to issue a print request.

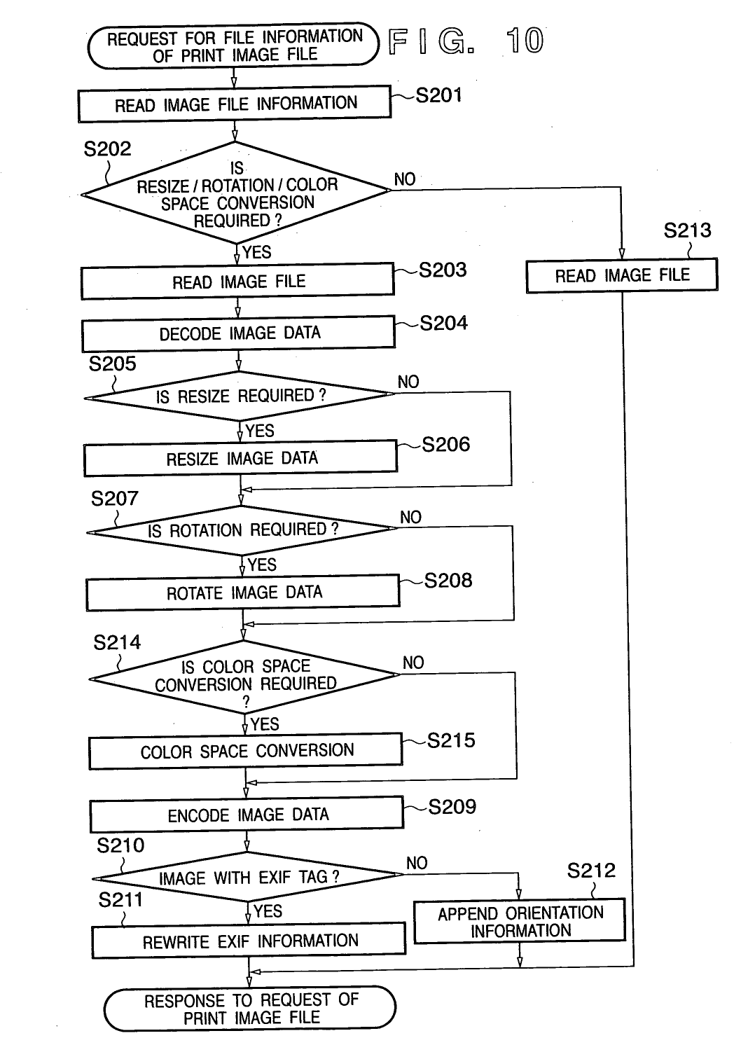

FIG. 10 is a flowchart for explaining a process of creating the print image file on the DSC 3012 corresponding to the processing of steps S7 to S9 of FIG. 7.

This processing is started by receiving a “request for file information of image file” from the PD printer 1000 (S24 in FIG. 7). First, in a step S201, the DSC reads file information of the image file included in the print job file on which the request for file information is based. Next, in a step S202, it is determined whether or not the processing of resizing, rotation or color conversion for the image data is required based on the print conditions for printing on the PD printer 1000 and the image data of the image file to be printed. If no processing is required, the procedure advances to step S213, where the image data to be printed is read from the memory card 3109 and the image data is sent to the PD printer 1000.

Thus, if it determines that the original image data requires some conversion in the step S202, the process advances to a step S203. In the step S203, the image data to be printed is read from the memory card 3109. In the step S204, the read image data is decoded to the original image data (raw image data). Next, in the step S205, it is determined whether or not the resizing process of the image data is required by comparing the longitudinal and transverse numbers of pixels of the printable image by the PD printer 1000 and the longitudinal and transverse numbers of pixels of the image data to be printed.

Herein, in the relationship of FIGS. 8A and 8B, namely, if the longitudinal and transverse numbers of pixels of the original image data as shown in FIG. 8A are larger than that of the printable image (FIG. 8B) by the PD printer 1000, then it is determined that the resizing process is required. In this case, at step S206, the image data is resized by the image resize processing unit 623, and the procedure advances to step S207. If it is determined that the resizing is not required in the step S205, the process advances to step S207.

At step S207, it is determined whether or not the rotation of image is required based on the designated print size and layout. If the rotation is not required, the process advances to step S214, but otherwise the procedure advances to step S208. In the step S208, the image data is rotated by the image rotation processing unit 624, and then the process advances to step S214.

At step S214, it is determined whether or not the color space conversion of the image data is required. If it is not required, the process advances to step S209, or if it is required, the process advances to step S215, where the color space conversion is performed by the image color processing unit 626. Thus, after the processing of resizing, rotation or color conversion has been performed, the processed image data is compressed by the image expansion/compression processing unit 625 at step S209. Though the compression method is not specifically referred to herein, the compression image format, which can be dealt with by the PD printer 1000, such as a reversible compression generally represented by PackBits or an irreversible compression represented by JPEG, can be selected. At step S210, it is determined whether or not the coded image data has an “EXIF” tag. If the image data is tagged with EXIF, the EXIF information is updated at step S211 according to the conversion process of the image data at steps S205 to S215. On the other hand, if there is no EXIF tag at step S210, the orientation information is appended to the compressed image data to create an image file for printing at step S212. The response data to the “request for file information of image file” from the PD printer 1000 is created and responded, based on the image file for printing created in this way (step S9 of FIG. 7).

In a case where the image data is rotated and transferred to the PD printer 1000, it is determined whether or not the image data is tagged with EXIF at step S210. If so, the EXIF information is rewritten at step S211, or if not, the orientation information indicating the rotation is appended at step S212.

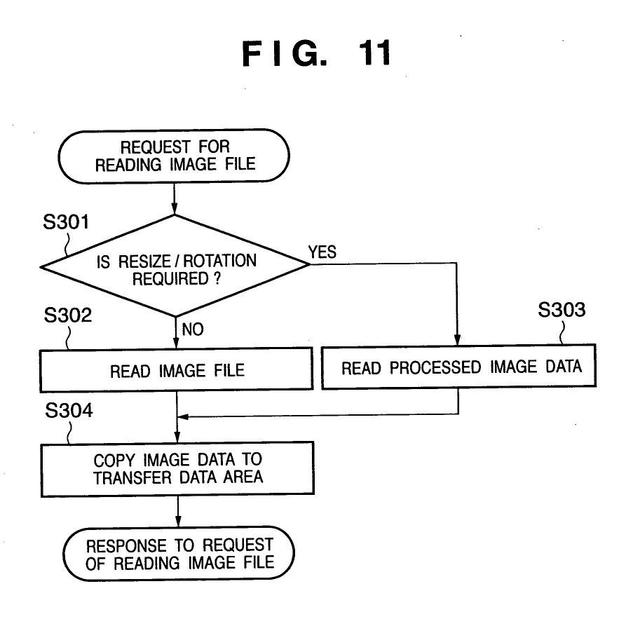

FIG. 11 is a flowchart for explaining a process of the DSC 3012 for “request for image file” from the PD printer 1000. This corresponds to the processing of steps S10 and S11 of FIG. 7.

If the “request for image file” to be printed is received from the PD printer 1000, it is determined whether or not the resizing and rotation process of the image data of the image file is required at step S301. If required, the process advances to step S303 to read the image data of the image file that is created in the process represented by the flowchart of FIG. 10. If not required, the image file stored in the memory card 3109 is read at step S302. And at step S304, the image data read at step S302 or step S303 is copied into a transfer data area of the RAM 3102, and the image data is transferred to the PD printer 1000 via the communication control unit 621 and the communication control unit 610.

In the flowchart of FIG. 10, if the image data read at step S213 or the image file processed at step S211 or S212 is stored in the transfer data area of the RAM 3102, the processing of steps S301 to S304 of FIG. 11 become unnecessary, whereby the processing of FIG. 11 includes simply sending the image data stored in the transfer data area.

As described above, according to the first embodiment, the image data is resized according to the number of pixels required for printing, thereby reducing the transfer data size in the print protocol dealing with the general-purpose image format such as JPEG image, JBIG image or TIFF image, so that the high speed printing is enabled without degrading the image quality.

Also, according to the first embodiment, in the above print protocol, the printable maximum width and height by the printer are acquired, and if the size of image data exceeds the maximum width and height, then the image data is resized into the printable width and height, so that it is possible for the printer to resize and print an image having the width and height beyond the printable size of the printer.

Also, according to the first embodiment, in the above print protocol, the printable maximum data size of image data of the printer is acquired, and if the data size of an image exceeds the maximum data size of the printer, the image data is resized into the data size of the printer, so that it is possible for the printer to print an image having the data size beyond the ability of the printer.

Also, according to the first embodiment, in the above print protocol, the printable color space information by the printer is acquired, and if the color space of an image is beyond the color space of the printer, the color space of the image data is converted into the printable color space of the printer, whereby it is possible to print the image of the color space beyond the color space of the printer.

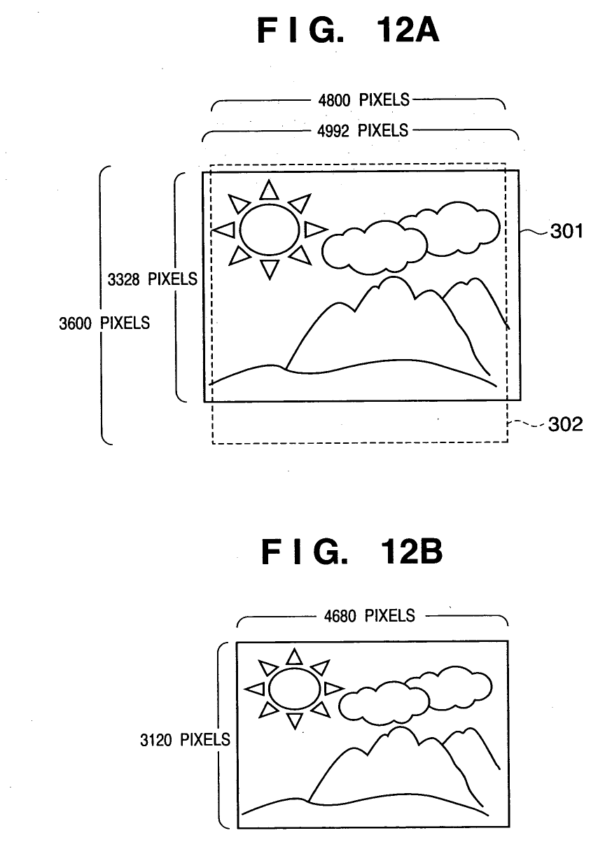

FIGS. 12A and 12B depict views for explaining a modified embodiment of the first embodiment.

In FIG. 12A, reference numeral 301 denotes image data stored in the memory card 3109, its size being 4992 pixels in width and 3328 pixels in height. On the other hand, reference numeral 302 designates the image size printable by the PD printer 1000, which is 4800 pixels in width and 3600 pixels in height.

In this case, the DSC 3012 multiplies the original image size (4992 pixels in width and 3328 pixels in height) by ( 15/16) to obtain the image width of 4680 pixels and the height of 3120 pixels, because it is determined in the step S 202 that the original image size exceeds the maximum image width and height printable of the PD printer 1000.

Also, it may be determined in step S202 that the resizing of the image is required, if the size of original image exceeds the printable maximum image data size.

Moreover, it may be determined in step S202 that the conversion of color space is required if the original image includes the color space in which the printer can not print.

[Second Embodiment]

A second embodiment of the invention will be described below. In the second embodiment, the UI of the DSC 3012 designates the priority level of color conversion, and the DSC implements the color conversion process in accordance with the set priority level at step S215 (FIG. 10).

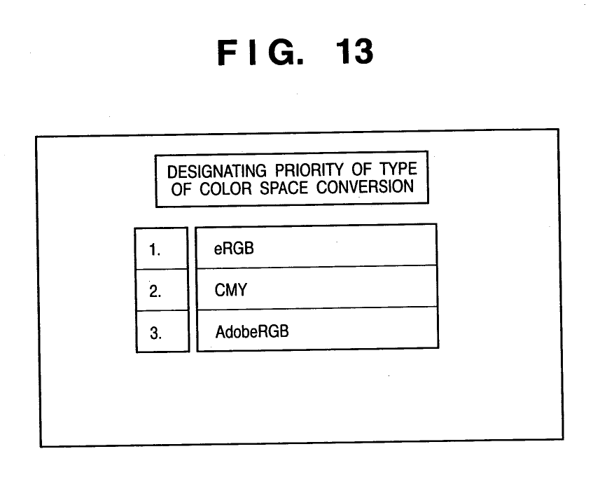

FIG. 13 depicts a view showing an example of a UI screen according to the second embodiment. Herein, any one of sRGB, CMY and AdobeRGB can be set as the color space conversion at the highest priority level.

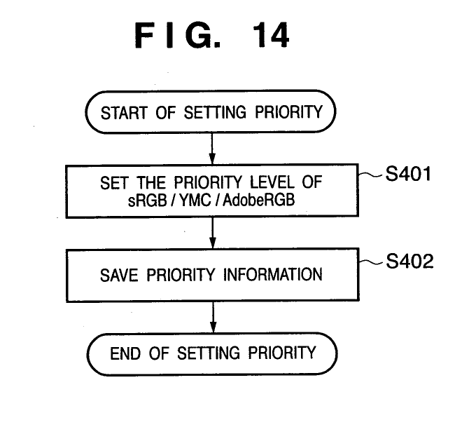

FIG. 14 is a flowchart for explaining a process in the DSC 3012 for setting up the priority level of color conversion according to the second embodiment.

At step S401, the screen as shown in FIG. 13 is displayed on the display 2700, and the priority level of the color space conversion is set up according to the user's operation on the screen. At step S402, the set priority level of the color space conversion is stored in the RAM 3102. The information stored in this way is read in the color conversion process at step S215 of FIG. 10, and set up as the color space for making the color space conversion.

According to the second embodiment, in the above print protocol, the priority level of the printable color space is set upon outputting image data to the printer, whereby the color space conversion is enabled according to the ability of the printer or user's preference, and the printing is performed by making the best use of the ability of printer.

Also, according to the second embodiment, the priority level of the printable color space is acquired upon outputting image data to the printer, whereby the color space conversion is enabled according to the ability of the printer, and the printing is performed by making the best use of the ability of printer.

[Third Embodiment]

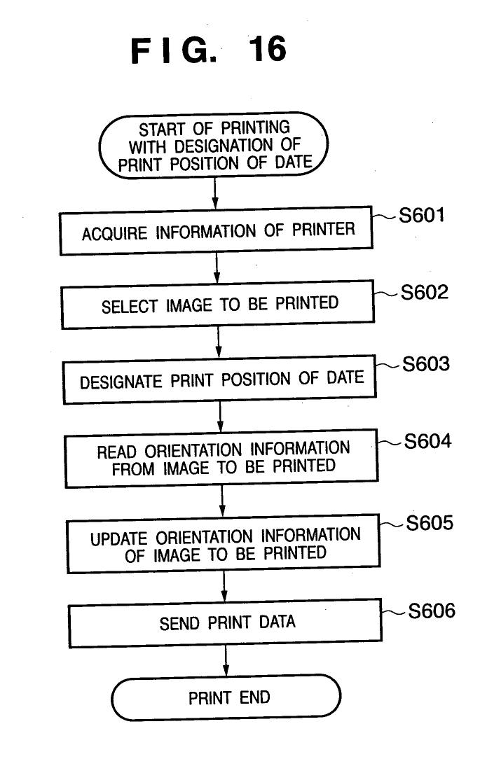

FIG. 16 is a flowchart for explaining a process in the DSC 3012 for designating a print position at which the date is printed on a photographed image according to a third embodiment of the invention. The date comprises year/month/day indicating the date in which the photographed image was taken.

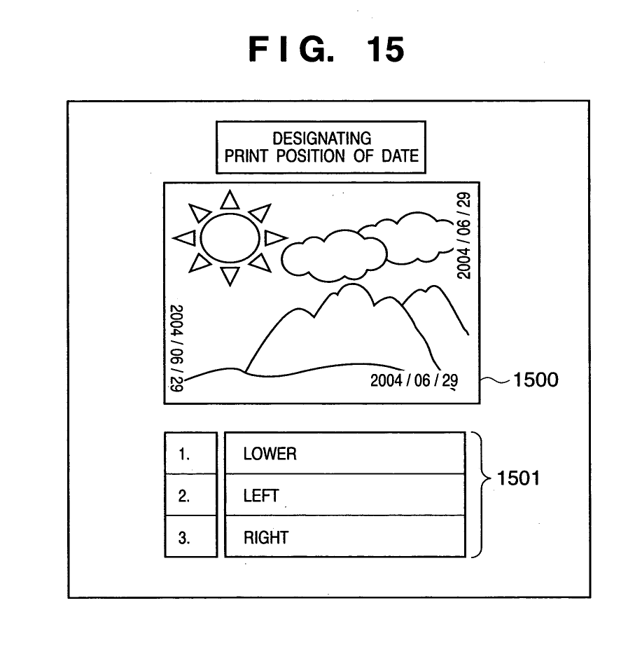

First, at step S601, the information of the PD printer 1000 is acquired. At step S602, an image to be printed is selected. At step S603, the print position of the date on the image is designated based on the screen as shown in FIG. 15.

FIG. 15 depicts a view showing an example of a UI screen for designating a print position at which the date of an image is printed on the image.

Reference numeral 1500 denotes an image display area, in which the position of date is specified in accordance with the position (lower, left or right) in a position designation column 1501.

And at step S604, the orientation information is read from the image data to be printed. At step S605, the orientation information of the print image is updated based on the read information and the location information with the specified position of date, and then the print data is sent to the PD printer 1000 at step S606.

According to the third embodiment, even if the image is rotated for high speed printing, the orientation information is updated according to the rotation of the image, so that the date can be printed at the proper position based on the orientation of the image.

Also, according to the third embodiment, the print position of the date of an image may be set at any position, and the orientation information of the image is updated according to the rotation of image and the print position is also updated, so that even if the image is rotated, the date can be printed at the proper position of the image based on the orientation information.

[Fourth Embodiment]

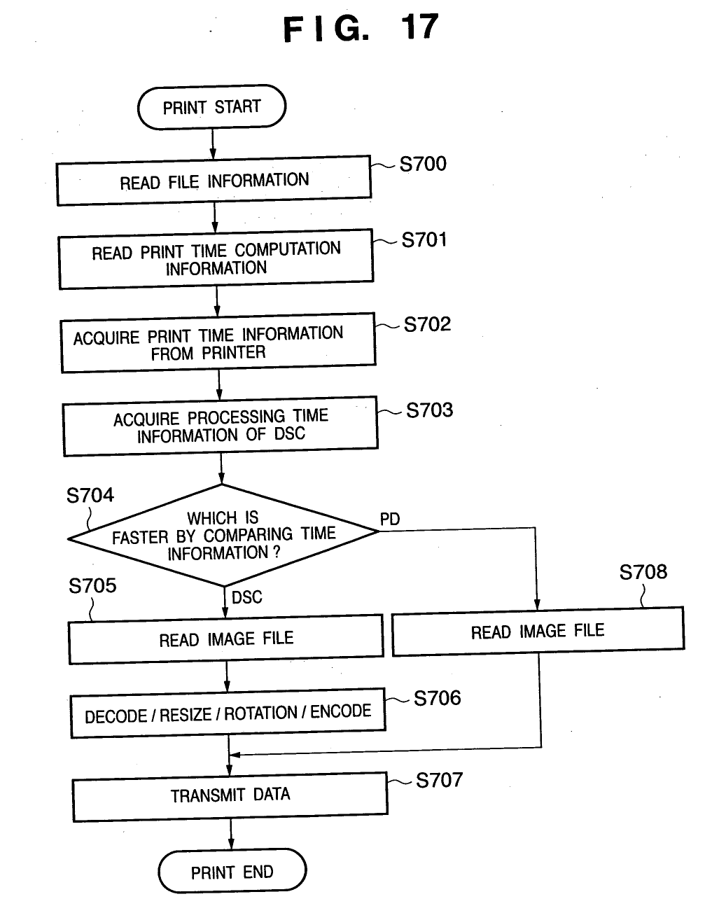

FIG. 17 is a flowchart for explaining a process in the DSC 3012 according to a fourth embodiment of the invention.

First, at step S700, file information of an image file to be printed is read, and the information required for printing including the width, height, file size and orientation of the image is obtained. At step S701, the past print log and the print time computation information prepared for every connected printer are read. At step S702, the information concerning the print time is acquired from the PD printer 1000. And at step S703, the time information concerning the image processing by the DSC 3012 is acquired. And at step S704, it is determined which of the DSC 3012 and the PD printer 1000 performs the image processing faster by comparing the time information. If it is determined that the processing by the DSC 3012 is faster, the process advances to step S705 to read the image file to be printed. At step S706, the image file is decoded, resized, rotated and encoded in the DSC.

On the other hand, if it is determined that the processing by the PD printer 1000 is faster at step S704, then the process advances to step S708 to read the image file to be printed. After the image file has been read, the image data is transferred to the PD printer 1000 at step S707, whereby the image data is decoded, resized, rotated and encoded in the PD printer 1000 to perform the printing.

According to the fourth embodiment, it is determined which of the printer 1000 and the DSC 3012 performs image processing to print faster, and the image processing is performed by either the printer or the DSC that is determined, such that the high speed printing is implemented.

[Fifth Embodiment]

A fifth embodiment of the invention will be described below.

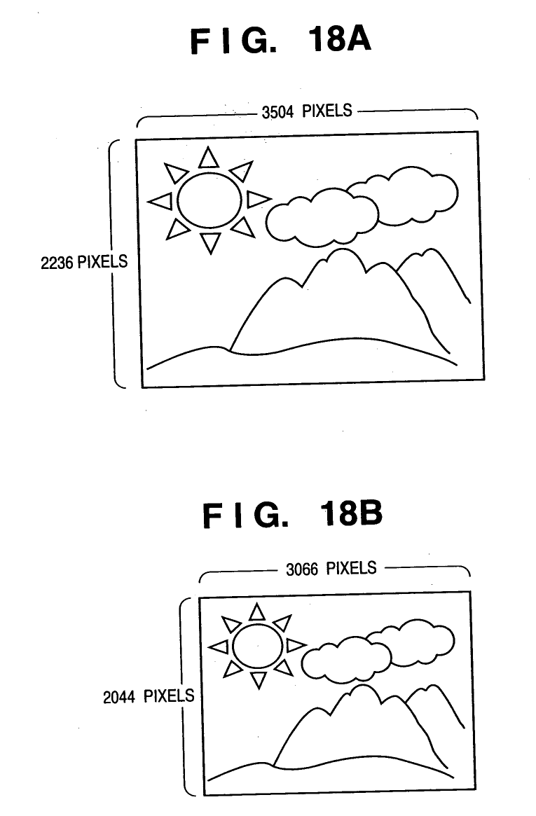

In the fifth embodiment, after the image of FIG. 18A is resized as shown in FIG. 18B, the resized image is printed bordering.

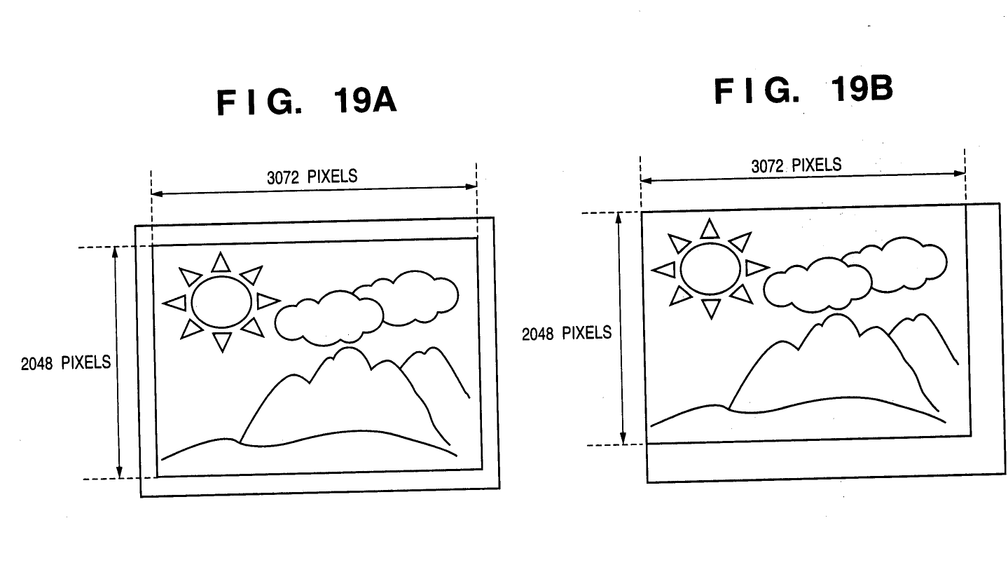

FIGS. 19A and 19B depict examples where the image data after resizing as shown in FIG. 18B is printed with “bordering”. FIG. 19A depicts an example in which the centering of the image is made, and FIG. 19B shows an example in which the image is printed in reference to the left upper corner of the image. As will be apparent from FIGS. 19A and 19B, the image size (3066 pixels in width×2044 pixels in height) after resizing as shown in FIG. 18B is changed into the size (3072 pixels in width×2048 pixels in height) in printing with “bordering”. Thereby, it is possible to prevent the trouble that a part of the image after resizing is deleted and printed upon printing with “bordering”.

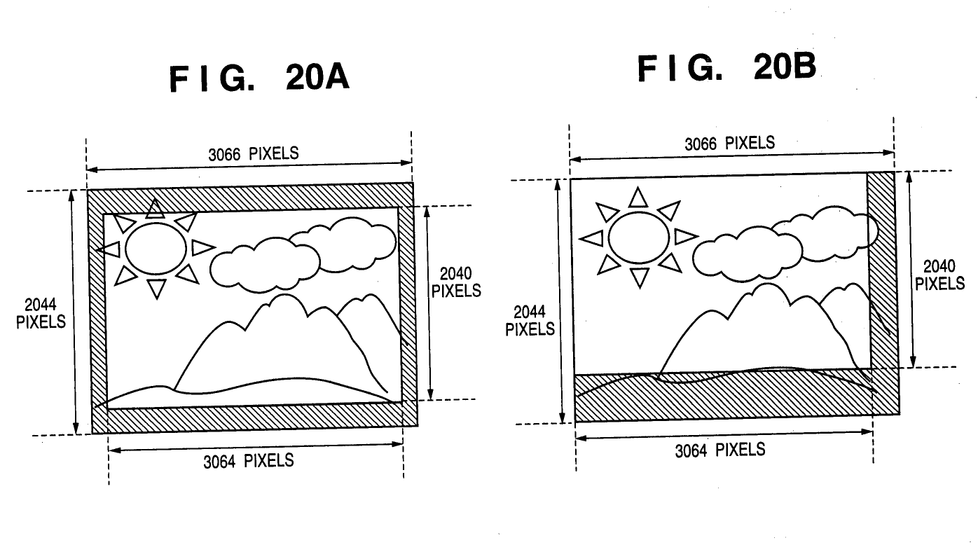

FIGS. 20A and 20B depict views showing the examples where the image data after resizing (3066 pixels in width×2044 pixels in height) as shown in FIG. 18B is printed with “borderless”. FIG. 20A shows an example in which the centering of the image is made (the image is centered in a sheet), and FIG. 20B shows an example in which the image is cropped and printed in reference to the left upper corner of the image and the sheet. In FIGS. 20A and 20B, the image size (3066 pixels in width×2044 pixels in height) after resizing as shown in FIG. 18B is changed into the size (3064 pixels in width×2040 pixels in height) in printing with “borderless”.

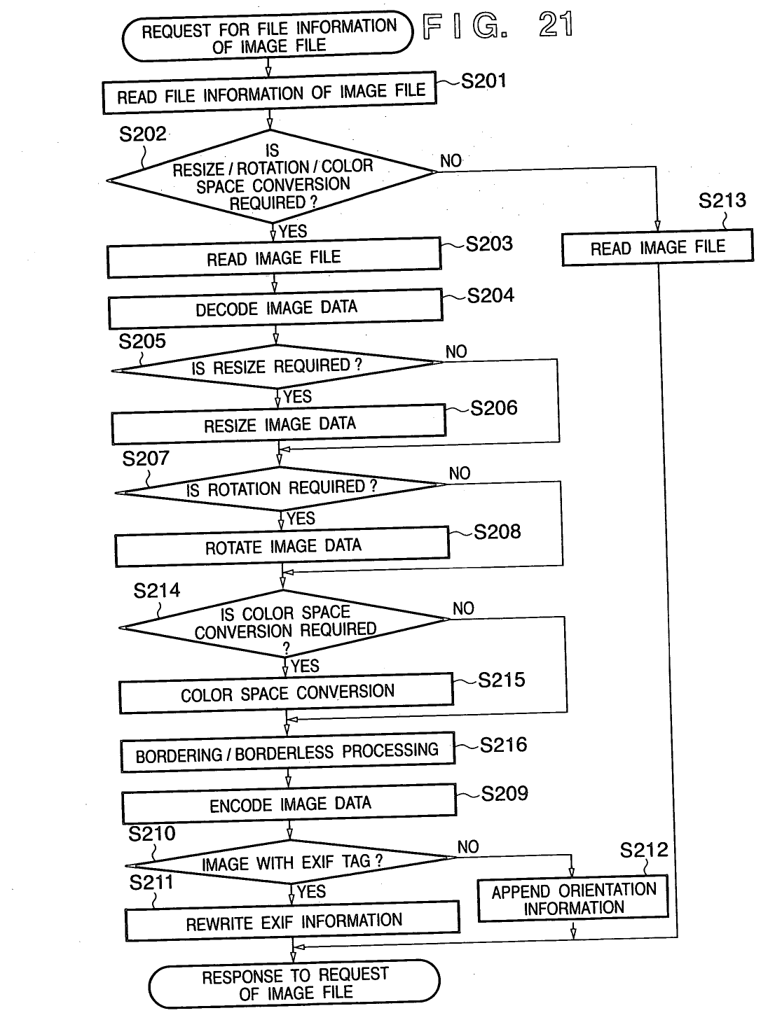

FIG. 21 is a flowchart for explaining a process of creating the image file in the DSC 3012 corresponding to the processing of steps S7 to S9 in FIG. 7. The common steps to those of FIG. 10 are designated by the same symbols and numerals, and the explanations thereof are omitted.

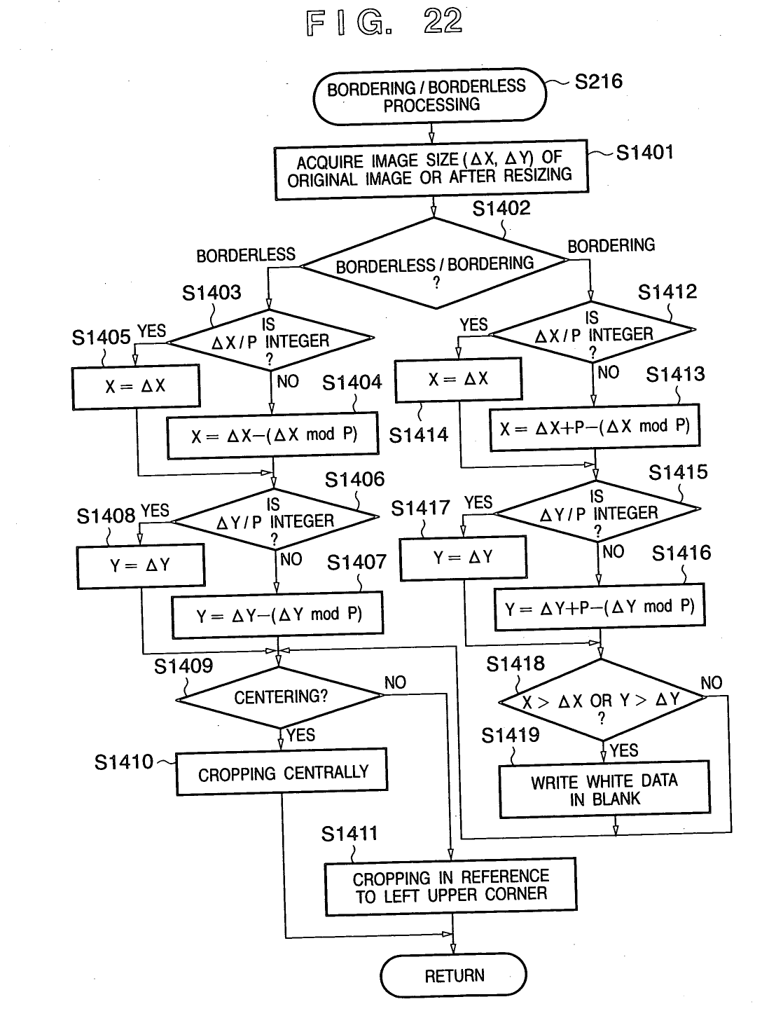

At step S214, it is determined whether or not the color space conversion of image data is required. If the color conversion is not required, the process advances to step S216, but if required, the process advances to step S215 where the color space conversion is made by the image color processing unit 626. Thus, after determining whether or not the processing of resizing, rotation and color conversion is required and performing the corresponding processing, the processing according to the print specification of “bordering”/“borderless” is performed at step S216. This processing will be described later with reference to a flowchart of FIG. 22.

FIG. 22 is a flowchart for explaining a “bordering”/“borderless” process at step S216 of FIG. 21.

First, at step S1401, the image size of original image or after resizing is acquired, in which the image size (width (longitudinal), height (transverse)) is defined as (ΔX, ΔY). In the example of FIG. 18B, ΔX=3066 and ΔY=2044. At step S1402, it is determined whether the print method is “bordering” or “borderless”. In the case of “borderless” printing, the process advances to step S1403 to determine whether or not the result of dividing ΔX by a prescribed constant (p) is the integer. This prescribed constant p is equal to 8 in view of the coding/decoding process in the fifth embodiment. The value of the prescribed constant p is not limited to “8”, but may be “16” or “32”, or a different prescribed constant p may be applied in the transverse direction or longitudinal direction. If it is determined that the result is the integer at step S1403, the width X of the image after conversion is equalized to ΔX at step S1405, but if the result is not the integer, the width X of the image is equalized to ΔX−(ΔX mod p) at step S1404. Herein, (ΔX mod p) indicates the remainder (residue) of ΔX divided by p. In the example of FIG. 18B, X=3066−(3066 mod 8)=3064.

Similarly, in respect of the height direction, at step S1406, it is determined whether or not the result of dividing the height ΔY of the image by the prescribed constant (p) is the integer. If it is determined that the result is integer, the height Y of the image after conversion is equalized to ΔY at step S1408, but if the result is not the integer, the height Y of the image is equalized to ΔY−(ΔY mod p) at step S1407. In the example of FIG. 18B, Y=2044−(2044 mod 8)=2040. Thus, the size of the image printed with “borderless” is decided. Next, at step S1409, it is determined whether the reference position for cropping the image is at the center of image or the left upper corner. If the reference position is at the center, the image is cropped in reference to the center at step S1410 (FIG. 20A), or if not, the image is cropped in reference to the left upper corner of the image at step S1411 (FIG. 20B).

On the other hand, if the printing is designated as “bordering” at step S1402, the process advances to step S1412 to determine whether or not the result of dividing ΔX by the prescribed constant (p) is the integer. If it is determined that the result is the integer at step S1412, the width X of the image after conversion is equalized to ΔX at step S1414, but if the result is not the integer, the width X of the image after conversion is equalized to ΔX+p−(ΔX mod p) at step S1413. Herein, (ΔX mod p) indicates the remainder (residue) of ΔX divided by p. In the example of FIG. 18B, X=3066+8−(3066 mod 8)=3072.

Similarly, in the height direction, at step S1415, it is determined whether or not the result of dividing the height ΔY of the image by the prescribed constant (p) is the integer. If it is determined that the result is the integer, the height Y of the image after conversion is equalized to ΔY at step S1417, but if the result is not the integer, the height Y of the image is equalized to ΔY+p−(ΔY mod p) at step S1416. In the example of FIG. 18B, Y=2044+8−(2044 mod 8)=2048. Thus, the size of the image printed in “bordering” is decided. Next, at step S1418, it is determined whether the size (X,Y) of the image after conversion is larger than the size (ΔX,ΔY) of the original image. If the size (X,Y) is larger than the size (ΔX,ΔY), the process advances to step S1419, where white data is added by an increased amount of pixels to coordinate the image size. In the example of the image as shown in FIGS. 18B and 19A, six pixels in the width direction, and four pixels in the height direction are increased, whereby white pixel data is added by the increased amount of pixels. For adding the white data, a method (centering) of adding the pixel almost evenly around the original image and a method (left upper reference) of adding the pixel to the lower side or right side of the image are provided, and any one may be employed. And the process advances to step S1409 to determine whether the reference position of the image in “bordering” is at the center of image or the left upper corner. If the reference position is at the center, the image is cropped in reference to the center of the image at step S1410 (FIG. 19A), or if not, the image is cropped in reference to the left upper corner of the image at step S1411 (FIG. 19B).

As described above, according to the fifth embodiment, even if the size of the image to be printed is resized according to the number of pixels required for printing in the print protocol dealing with the general-purpose image format such as JPEG, JBIG or TIFF, there is no image defect that a part of the original image is cut, when the image is printed in “bordering”.

Also, according to the fifth embodiment, in any of the “borderless”/“bordering” printing, since the reference position of the image can be set at the center or left upper corner of the original image, the margin may be arranged almost evenly vertically or laterally. Also, in the printing in “borderless”, since a cropping area of the image can be set in reference to the center or the left upper corner of the image, a desired image portion can be securely included in the print image in “borderless”.

[Sixth Embodiment]

In the fifth embodiment, the white data is added or truncated so that the size of image after resizing may become the integral multiple of prescribed constant p. In the sixth embodiment, the size of original image is changed before resizing so that the size of image after resizing may be the integral multiple of prescribed constant p, and then the image is resized. The hardware configuration of the DSC 3012 and the PD printer 1000 according to the sixth embodiment is the same as that of the previous embodiments, and the explanation thereof is omitted.

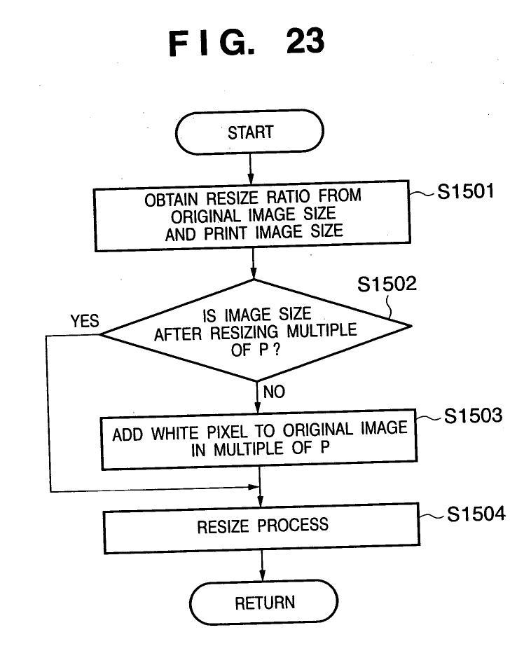

FIG. 23 is a flowchart for explaining a resizing process in the DSC 3012 according to the sixth embodiment of the invention. This process is performed at step S206 of FIGS. 10 and 21.

At step S1501, the resizing ratio is obtained from the size of original image and the size of print image. It is determined whether or not the image size after resizing is the integral multiple of prescribed constant p based on the resizing ratio and the size of original image. If the size of the resized image is the integral multiple, the resizing process is performed at step S1504. If the size of the resized image is not the integral multiple of the constant p, the process advances to step S1503, where the white pixel (white data) is added to the original image data so that the image size after resizing may be the integral multiple of prescribed constant p. The addition of white pixel is made by adding white data evenly around the original image (FIG. 19A), or to the lower side or right side of the original image as shown in FIG. 19B. And the process advances to step S1504, where the image data to which the white data is added is resized.

This process may be made in rotating the image, besides resizing.

Thereby, according to the sixth embodiment, as well as in the fifth embodiment, it is unnecessary to perform the process of adding or truncating the pixel data to or from the image data after resizing, according to the “bordering” or “borderless” print.

As an addition method of white data, whether the white data is added evenly around or offset in either direction is favorably decided depending on whether to print the auxiliary information such as date. That is, upon printing the date, it is desirable that the addition area of white data is offset, and the data such as date may be printed to the area. Moreover, for the print area of date and white data, it is more preferable to reflect the direction (tilt) of camera at the time of photographing the image. Specifically, for the image (landscape) photographed ordinarily in the transverse position, the white data is added to the right lower part of the image to append the date in the right lower part, because the date is usually placed under the image. On the other hand, for the image (portrait) photographed in the longitudinal position, it is preferable that the white data is added to either the left or right side area (as 1502, 1503 in FIG. 15), because the date is suitably appended to the lower position when the image is seen at a portrait form. In this way, it is very user-friendly to offset the location at which the white data is added to the image data according to the rotation information.

Also, when it is desired to make a layout of arranging a memorandum area on an image, considering a case of writing a memorandum in a blank area, it is preferable that the white data is offset and added. In this case, the user may select a layout or a mode to arrange the memorandum area on an image. As the result, the user can determine whether the memorandum area is printed or not on the image. Further, a position of the memorandum area may be determined according to a landscape image or a portrait image.

[Other Embodiments]

The object of the invention is achieved by providing a storage medium recording a program code of software that implements the functions of the embodiments to the system or apparatus, and reading and executing the program code stored in the storage medium by the computer (or CPU or MPU) of the system or apparatus. In this case, the program code itself read from the storage medium implements the functions of the above embodiments, and the storage medium storing the program code constitutes the invention. The storage medium for supplying the program code may be a floppy (registered trademark) disk, a hard disk, an optical disk, an optical magnetic disk, a CD-ROM, a CD-R, a magnetic tape, a non-volatile memory card or a ROM.

Also, the read program code may be executed by the computer to implement the functions of the above embodiments, and an OS (Operating System) running on the computer may perform a part or all of the actual processing to implement the functions of the above embodiments, based on the instructions of the program code.

Moreover, the program code read from the storage medium may be written into a memory equipped in a function extension board inserted into the computer or a function extension unit connected to the computer, and a CPU equipped on the function extension board or function extension unit may perform a part or all of the actual processing to implement the functions of the above embodiments, based on the instructions of the program code.

The present invention is not limited to the above embodiment, and various changes and modifications can be made thereto within the spirit and scope of the present invention. Therefore, to apprise the public of the scope of the present invention, the following claims are made.

### CLAIM OF PRIORITY

This application claims priority from Japanese Patent Application Nos. 2004-241201 and 2004-241202 filed on Aug. 20, 2004, which are hereby incorporated by reference herein.

What is claimed is:

1. A printing system having an image supply device and a printer, for printing an image based on image data supplied from the image supply device, wherein
the image supply device comprising:
storage means for storing coded image data;
means for acquiring print function information of the printer in accordance with a communication between the image supply device and the printer;
means for configuring and displaying a UI based on the print function information;
conversion means for making resizing and/or rotation of the image data to be printed that is stored in said storage means, in accordance with a print size and a print direction set based on the UI and the print function information; and
transmission means for transmitting the image data converted by said conversion means to the printer in response to a data request the said printer;
wherein the printer prints an image based on the image data transmitted by said transmission means in response to the data request.

2. The system according to claim 1, wherein said conversion means comprises:
decoding means for decoding the coded image data; resize means for resizing image data decoded by said decoding means;
rotation means for rotating image data decoded by said decoding means; and
coding means for coding image data processed by at least one of said resize means and said rotation means.

3. The system according to claim 1, further comprising:
designation means for designating a print position of date information for the image data; and
update means for updating the print position of the date information designated by said designation means in accordance with rotation of the image data, in a case where the image data to be printed is rotated by said conversion means.

4. The system according to claim 1, wherein the print function information of the printer includes a maximum printable size, and
said conversion means makes resizing and/or rotation of the image data to be printed that is stored in said storage means in accordance with the print function information and the size of the image data.

5. The system according to claim 1, wherein the print function information includes information of printable color space of the printer, and
further comprising color space conversion means for converting a color space of image data to be printed in accordance with the information of printable color space included in the print function information and the color space of the image data to be printed that is stored in said storage means,
wherein said transmission means transmits image data converted by said color space conversion means to the printer in response to a data request from the printer.

6. The system according to claim 5, further comprising setting means for setting the priority of the type of color space to be converted by said color space conversion means.

7. The system according to claim 1, wherein said transmission means transmits the image data with orientation information or tag information in accordance with the resizing or conversion of the image data to be transmitted.

8. An image supply device for supplying image data to a printer by directly communicating with the printer, comprising:
storage means for storing coded image data;
means for acquiring print function information of the printer in accordance with a communication with the printer;
means for configuring and displaying a UI based on the print function information;
conversion means for making resizing and/or rotation of image data to be printed that is stored in said storage means, in accordance with a print size and a print direction set up based on the UI and the print function information; and
transmission means for transmitting image data converted by said conversion means to the printer in response to a data request from the printer.

9. The device according to claim 8, wherein said conversion means comprising:
decoding means for decoding the coded image data;
resize means for resizing image data decoded by said decoding means;
rotation means for rotating image data decoded by said decoding means; and
coding means for coding image data processed by said resize means and said rotation means.

10. The device according to claim 8, further comprising:
designation means for designating a print position of date information for the image data; and
update means for updating a print position of date information designated by said designation means in accordance with the rotation, in a case where the image data to be printed has been rotated by said conversion means.

11. The device according to claim 8, wherein the print function information of the printer includes a maximum printable size, and
said conversion means makes resizing and/or rotation of the image data to be printed that is stored in said storage means in accordance with the print function information and the size of the image data.

12. The device according to claim 8, wherein the print function information includes information of printable color space of the printer, and
further comprising color space conversion means for converting a color space of image data to be printed in accordance with the information of printable color space included in the print function information and the color space of the image data to be printed that is stored in said storage means,
wherein said transmission means transmits image data converted by said color space conversion means to the printer in response to a data request from the printer.

13. The device according to claim 12, further comprising setting means for setting the priority of the type of color space to be converted by said color space conversion means.

14. The device according to claim 8, wherein said transmission means transmits the image data with orientation information or tag information of the image data in accordance with the resizing or conversion of the image data to be transmitted.

15. A control method of an image supply device for supplying image data to a printer by directly communicating with the printer, the method comprising:
a step of acquiring print function information of the printer in accordance with a communication with the printer;
a step of configuring and displaying a UI based on the print function information;
a conversion step of making the resizing and/or rotation of image data to be printed in accordance with a print size and a print direction set up based on the UI and the print function information; and
a transmission step of transmitting image data converted in said conversion step to the printer in response to a data request from the printer.

16. The method according to claim 15, wherein said conversion step comprising:
a decoding step of decoding the coded image data;
a resizing step of resizing image data decoded in said decoding step;
a rotation step of rotating image data decoded in said decoding step; and
a coding step of coding image data processed in said resize step and said rotation step.

17. The method according to claim 15, further comprising a designation step of designating a print position of date information for the image data; and
an update step of updating the print position of date information designated in said designation step in accordance with the rotation in a case where the image data to be printed is rotated in said conversion step.

18. The method according to claim 15, wherein the print function information of the printer includes a maximum printable size, and
in said conversion step, resizing and/or rotation of the image data to be printed is implemented in accordance with the print function information and the size of the image data.

19. The method according to claim 15, wherein the print function information includes information of printable color space of the printer, and
further comprising a color space conversion step of converting a color space of image data to be printed in accordance with the information of printable color space included in the print function information and the color space of the image data to be printed,
wherein in said transmission step, image data converted by said color space conversion means is transmitted to the printer in response to a data request from the printer.

20. The method according to claim 19, further comprising a setting step of setting the priority of the type of the color space to be converted in said color space conversion step.

21. The method according to claim 15, wherein said transmission step comprises a step of transmitting the image data with orientation information or tag information of the image data in accordance with the resizing or conversion of the image data to be transmitted.

22. The method according to claim 15, wherein the image supply device stores function information of the printer corresponding to type information of a printer, and acquires the function information of the printer connected for communication by referring to the stored function information based on the type information acquired from the printer in communication with the printer.

23. A printing system having an image supply device and a printer, for printing an image based on image data supplied from the image supply device, wherein
the image supply device comprising:
storage means for storing coded image data;
means for acquiring print function information of the printer in accordance with a communication between the image supply device and the printer;
means for configuring and displaying a UI based on the print function information;
resizing means for resizing image data to be printed that is stored in said storage means in accordance with a print size set up based on the UI;
first image conversion means for converting image data into image data with pixel added to make the size of the image the integral multiple of a prescribed number, if the size of the image resized by said resize means is not the integral multiple of the prescribed number, when a borderless print is designated based on the UI; and
transmission means for transmitting image data of the image converted by said first image conversion means to the printer in response to a data request from the printer;
wherein the printer prints an image based on the image data transmitted by said sending means in response to the data request.

24. An image supply device comprising:
storage means for storing coded image data;
means for acquiring print function information of the printer in accordance with a communication with the printer;
means for configuring and displaying a UI based on the print function information;
resizing means for resizing image data to be printed that is stored in said storage means in accordance with a print size set up based on the UI;
first image conversion means for converting image data into image data with pixel added to make the size of the image the integral multiple of a prescribed number, if the size of the image resized by said resizing means is not the integral multiple of the prescribed number, when a bordering print is designated based on the UI; and
transmitting means for transmitting image data of the image converted by said first image conversion means to the printer in response to a data request from the printer.

25. The device according to claim 24, further comprising:
second image conversion means for converting the image data into image data with pixel deleted to make the size of image the integral multiple of the prescribed number, if the size of image resized by said resize means is not the integral multiple of the prescribed number, in a case where a borderless print is designated based on the UI, in which said transmitting means transmits the image data of the image converted by said first or second image conversion means to the printer in response to a data request from the printer.

26. The system according to claim 24, wherein said resizing means comprises decoding means for decoding the coded image data, means for resizing the image data decoded by said decoding means, and coding means for coding image data converted by said first image conversion means.

27. The system according to claim 24, further comprising means for designating whether or not an image represented by the image data converted by said first image conversion means is centered with reference to an original image.

28. The printing system according to claim 27, further comprising means for designating whether or not an image represented by the image data converted by said second image conversion means is centered with reference to an original image.

29. A control method of an image supply device comprising:
a step of acquiring print function information of a printer in accordance with a communication with the printer;
a step of configuring and displaying a UI based on the print function information acquired in said acquiring step;
a resize step of resizing image data to be printed in accordance with a print size set up based on the UI;
a first image conversion step of converting image data into image data with pixel added to make the size of image the integral multiple of a prescribed number, if the size of the image resized in said resize step is not the integral multiple of the prescribed number, in a case where a bordering print is designated based on the UI; and
a transmission step of transmitting image data of converted in said first image conversion step to the printer in response to a data request from the printer.

30. The method according to claim 29, further comprising a second image conversion step of converting image data into image data with pixel deleted to make the size of image the integral multiple of the prescribed number, if the size of image resized in said resize step is not the integral multiple of the prescribed number, in a case where a borderless print is designated based on the UI, in which said transmission step comprises transmitting the image data converted in said first or second image conversion step to the printer in response to a data request from the printer.

31. The method according to claim 29, wherein said resize step comprising:
a decoding step of decoding the coded image data;
a step of resizing image data decoded in said decoding step; and
a coding step of coding image data converted in said first image conversion step.
